(19) United States
(12) Patent Application Publication
(10) Pub. No.: US 2016/0096693 A1
(43) Pub. Date: Apr. 7, 2016

(54) MATERIAL CONVEYANCE DEVICE AND MATERIAL CONVEYANCE METHOD

(71) Applicant: MATSUI MFG. CO., LTD., Osaka (JP)

(72) Inventors: Kazunari HANAOKA, Osaka (JP); Saiji YAMASHITA, Osaka (JP); Takahiro MATSUDA, Osaka (JP)

(21) Appl. No.: 14/131,561

(22) PCT Filed: Mar. 29, 2013
(86) PCT No.: PCT/JP2013/059468

§ 371 Date: Jan. 8, 2014

(51) Int. Cl. B65G 53/66; B65G 53/26

(52) U.S. Cl. CPC B65G 53/66; B65G 53/26

(57) ABSTRACT

A material conveyance device that has an inverter converting a frequency of an alternating-current source and a suction air source having an electric motor driven by the inverter and pneumatically conveys a material by the suction air source through a pipe for conveying the material, includes: a physical quantity detector that detects a physical quantity related to an output of the inverter; and a controller that controls an air volume or an air speed by the suction air source based on the physical quantity detected by the physical quantity detector.

### CROSS-REFERENCE TO RELATED APPLICATIONS

This application is the national phase under 35 U.S.C. §371 of PCT International Application No. PCT/JP2013/059468 which has an International filing date of Mar. 29, 2013 and designated the United States of America.

### BACKGROUND

1. Technical Field

The present invention relates to a material conveyance device that has an inverter converting the frequency of an alternating-current source and a suction air source having an electric motor driven by the inverter and pneumatically conveys a material by the suction air source through a pipe for conveying the material, and a material conveyance method.

2. Description of Related Art

Conventionally, a material conveyance device has been in practical use in which a material (for example, a powder and granular material) pneumatically conveyed from a material supply source is collected with a collector or the like and accommodated, and the material pneumatically conveyed through an input pipe, a storage tank or the like provided at the outlet of the collector is supplied to a molding machine or the like.

In such a material conveyance device, for example, a material source valve is provided between a material hopper and a dryer, and a collector connected to a molding machine and the dryer are interconnected by a pipe. The material is conveyed by suction from the dryer to the collector by being conveyed by air sucked by a suction blower provided at the collector (see Japanese Patent Application Laid-Open No. 2000-33618).

### SUMMARY

When a material (for example, a powder and granular material) is pneumatically conveyed, if the air speed in the pipe is low, the material becomes stagnant in the pipe. Conversely, if the air speed in the pipe is high, the material rubs in the pipe and this causes snaking or whiskers on the material, so that the quality of the material is degraded. Moreover, there are cases where change of the kind of the material to be pneumatically conveyed changes the specific gravity and the like of the material and this changes the pipe resistance or pressure to cause stagnation of the material. Moreover, change of the supply amount of the material according to the consumption amount of the material changes the mixing ratio (the material conveyance amount per unit air) and this changes the air speed or the pressure in the pipe to make stable pneumatic conveyance impossible. For these reasons, in the conventional pneumatic conveyance, it is necessary to secure a required pneumatic conveyance condition by manually adjusting the output of the suction air source (for example, a pump or a blower) and measuring the air volume (or the air speed), the pressure or the like in the pipe every time the material to be pneumatically conveyed is changed or every time the consumption amount of the material is changed.

The present invention is made in view of such circumstances, and an object thereof is to provide a material conveyance device and a material conveyance method in which stagnation or quality degradation of the material is prevented to allow pneumatic conveyance of a material to be performed under an optimum condition.

A material conveyance device according to a first aspect of the invention is a material conveyance device that has an inverter converting a frequency of an alternating-current source and a suction air source having an electric motor driven by the inverter and pneumatically conveys a material by the suction air source through a pipe for conveying the material, and is characterized by including: a physical quantity detector that detects a physical quantity related to an output of the inverter; and a controller that controls an air volume or an air speed by the suction air source based on the physical quantity detected by the physical quantity detector.

The material conveyance device according to a second aspect of the invention is characterized in that, in the first aspect of the invention, the physical quantity detector detects at least one of torque, current and power of the electric motor in the first aspect of the invention.

The material conveyance device according to a third aspect of the invention is characterized in that, in the first and the second aspects of the invention, the controller controls the air volume or the air speed by the suction air source by controlling the frequency converted by the inverter in the first or the second aspect of the invention.

The material conveyance device according to a fourth aspect of the invention is characterized, in any one of the first through the third aspects of the invention, by including: a pressure calculator that calculates a pressure by the suction air source based on the physical quantity detected by the physical quantity detector; and an air volume calculator that calculates the air volume or the air speed by the suction air source based on the pressure calculated by the pressure calculator and a pressure/air volume characteristic representative of a relationship between the pressure and the air volume of the suction air source and in that the controller controls the frequency converted by the inverter so that the air volume or the air speed calculated by the air volume calculator is within a required range in any one of the first to third aspects of the invention.

The material conveyance device according to a fifth aspect of the invention is characterized, in the fourth aspect of the invention, by including an air volume display portion that displays the air volume or the air speed calculated by the air volume calculator in the fourth aspect of the invention.

The material conveyance device according to a sixth aspect of the invention is characterized, in the fourth and the fifth aspects of the invention, by including a pressure display portion that displays the pressure calculated by the pressure calculator in the fourth or the fifth aspect of the invention.

The material conveyance device according to a seventh aspect of the invention is characterized, in any one of the first through the sixth aspects of the invention, by including: a material supply portion that supplies the material by rotating a material container; a material supply inverter that converts the frequency of the alternating-current source and adjusts a number of rotations of the material container according to the converted frequency; and a supply amount controller that controls, in order that a mixing ratio of the material is within a required range, a supply amount of the material by controlling the frequency converted by the material supply inverter, according to the air volume or the air speed by the suction air source in any one of the first to sixth aspects of the invention.

The material conveyance device according to an eighth aspect of the invention is characterized, in the seventh aspect of the invention, by including a determiner that determines whether the physical quantity detected by the physical quantity detector is not less than a predetermined threshold value or not and in that when the physical quantity is not less than the predetermined threshold value at the determiner, the supply amount controller decreases the supply amount of the material by decreasing the frequency converted by the material supply inverter in the seventh aspect of the invention.

The material conveyance device according to a ninth aspect of the invention is characterized, in the eighth aspect of the invention, by including a notifier that, when the physical quantity is not less than the predetermined threshold value at the determiner, provides a notification to that effect in the eighth aspect of the invention.

The material conveyance device according to a tenth aspect of the invention is characterized, in any one of the seventh through the ninth aspects of the invention, by including a consumption amount calculator that calculates a consumption amount of the material and in that the supply amount controller controls the supply amount of the material by controlling the frequency converted by the material supply inverter, according to the consumption amount calculated by the consumption amount calculator in any one of the seventh to ninth aspects of the invention.

The material conveyance device according to an eleventh aspect of the invention is characterized in that, in any one of the first through the tenth aspects of the invention, the controller controls, in order that the mixing ratio of the material is within the required range, the air volume or the air speed by the suction air source by controlling the frequency converted by the inverter, according to the supply amount of the material in any one of the first to tenth aspects of the invention.

The material conveyance device according to a twelfth aspect of the invention is characterized in that, in any one of the first through the tenth aspects of the invention, the controller controls, in order that the air volume or the air speed by the suction air source is within the required range, the frequency converted by the inverter, according to the supply amount of the material in any one of the first to tenth aspects of the invention.

The material conveyance device according to a thirteenth aspect of the invention is characterized, in any one of the tenth through the twelfth aspects of the invention, by including: an accommodation portion that captures and accommodates the material conveyed through the pipe; and a first detector for detecting a material supply start time point and a second detector for detecting a material supply stop time point which the first and the second detectors are provided at different positions of the accommodation portion and in that the consumption amount calculator calculates the consumption amount of the material based on a time difference between the supply start time point and the supply stop time point and an amount of material accommodated between the first detector and the second detector of the accommodation portion in any one of the tenth to twelfth aspects of the invention.

A material conveyance method according to a fourteenth aspect of the invention is a material conveyance method by a material conveyance device that has an inverter converting a frequency of an alternating-current source and a suction air source having an electric motor driven by the inverter and pneumatically conveys a material by the suction air source through a pipe for conveying the material, and is characterized by including: a step of detecting a physical quantity related to an output of the inverter; and a step of controlling an air volume or an air speed by the suction air source based on the detected physical quantity.

In the first aspect and the fourteenth aspect of the invention, the physical quantity detector detects the physical quantity related to the output of the inverter. The physical quantity related to the output of the inverter is, for example, the torque of the electric motor, and may include a current and a load current that can be converted to the torque of the electric motor and the output power of the electric motor. The physical quantity detector may be provided inside the inverter, or a sensor may be provided on the side of the electric motor for the detection.

The controller controls the air volume or the air speed by the suction air source based on the physical quantity detected by the physical quantity detector. When the air volume is Q, the air speed is S and the internal diameter of the pipe is d, S=Q/(π×d²/4) holds. The torque of the electric motor and the pressure or the pipe resistance in the pipe are proportional to each other. Moreover, the pressure/air volume characteristic representative of the relationship between the pressure and the air volume of the suction air source may be obtained in advance. Moreover, the air volume in the pipe is proportional to the number of rotations of the rotary shaft of the electric motor of the suction air source, that is, the frequency converted by the inverter. By controlling the frequency of the inverter so as to increase or decrease, the air volume in the pipe can be made an optimum value on the pressure/air volume characteristic of the suction air source. Consequently, the air volume or the air speed is prevented from being too low or being too high to prevent stagnation or quality degradation of the material, so that pneumatic conveyance of the material can be performed under an optimum condition.

In the second aspect of the invention, the physical quantity detector detects at least one of the torque, the current or the power (output power) of the electric motor. Consequently, feedback for controlling the frequency converted by the inverter can be performed by using the torque, the current or the power of the electric motor detected by the physical quantity detector.

In the third aspect of the invention, the controller controls the air volume or the air speed by the suction air source by controlling the frequency converted by the inverter. Between the rotation speed of the rotary shaft of the electric motor of the suction air source and the air volume by the suction air source, a relationship of the air volume being proportional to the rotation speed holds. Since the rotation speed of the rotary shaft of the electric motor is proportional to the frequency converted by the inverter, the air volume or the air speed by the suction air source is proportional to the frequency converted by the inverter. Therefore, by controlling the frequency of the inverter, the air volume or the air speed can be controlled, and at the same time, the pressure (negative pressure) of the air can be controlled according to the pressure/air volume characteristic of the suction air source.

In the fourth aspect of the invention, the pressure calculator calculates the pressure by the suction air source based on the physical quantity detected by the physical quantity detector. When the detected physical quantity, for example, the torque of the electric motor is T and the pressure by the suction air source is P, the pressure can be calculated by an expression P=c×T+d. Here, the constants c and d are determined by the specifications or the like of the suction air source. The air volume calculator calculates the air volume or the air speed by the suction air source based on the calculated pressure and the pressure/air volume characteristic representative of the relationship between the pressure and the air volume of the suction air source. The pressure/air volume characteristic of the suction air source differs depending on the number of rotations of the electric motor of the suction air source. Therefore, the air volume may be calculated from the pressure by storing the pressure value and the air volume value on the pressure/air volume characteristic depending on the number of rotations so as to be associated with each other or by an expression (including an approximate expression) representative of the pressure/air volume characteristic.

The controller controls the frequency, converted by the inverter, so that the calculated air volume or air speed is within a required range. That is, by presetting an optimum required range of the air volume or the air speed where no material stagnation or material quality degradation is caused, the controller controls the frequency, converted by the inverter, so that the calculated air volume or air speed is within the required range. Consequently, stagnation or quality degradation of the material is prevented to allow pneumatic conveyance of the material to be performed under an optimum condition.

In the fifth aspect of the invention, the air volume display portion displays the air volume or the air speed calculated by the air volume calculator. Consequently, it is unnecessary to provide an air speed meter or an air volume meter in the pipe.

In the sixth aspect of the invention, the pressure display portion displays the pressure calculated by the pressure calculator. Consequently, it is unnecessary to provide a pressure meter in the pipe. In addition, there are no pressure measurement errors arising from the use of the pressure meter, so that the air pressure can be obtained with precision.

In the seventh aspect of the invention, the material supply portion supplies the material by rotating the material container. The material supply portion is constituted, for example, by a material accommodation tank having a rotary valve. That is, the material supply portion is structured, for example, as follows: A plurality of material containers are appropriately arranged, the rotary shaft of the electric motor rotates to thereby rotate in order the material containers accommodating a predetermined amount of material, and the material accommodated in the material containers is discharged into the pipe at a predetermined position. The material supply inverter is capable of adjusting the supply amount of the material by changing the number of rotations of the rotary shaft of the electric motor according to the converted frequency to thereby adjust the number of rotations of the material containers.

The supply amount controller controls, in order that the mixing ratio of the material is within the required range, the supply amount of the material by controlling the frequency converted by the material supply inverter according to the air volume or the air speed by the suction air source. The mixing ratio is a value representative of how much material can be conveyed per unit air. When the supply amount of the material per unit time is W and the air volume is Q, the mixing ratio μ can be expressed as μ=k×W/Q. Here, k is a constant. For example, when the mixing ratio μ is below the required range in a case where control is performed at an optimum air volume Q where no stagnation or quality degradation of the material is caused, the mixing ratio μ is made within the required range by increasing the supply amount W of the material by increasing the frequency of the material supply inverter. When the mixing ratio μ is higher than the required range, the mixing ratio μ is made within the required range by decreasing the supply amount W of the material by decreasing the frequency of the material supply inverter. By doing this, the required material can be supplied while control is performed at the optimum air volume Q where no stagnation or quality degradation of the material is caused.

In the eighth aspect of the invention, the determiner determines whether the detected physical quantity is not less than the predetermined threshold value or not. The physical quantity is, for example, the torque of the electric motor. When the physical quantity is not less than the predetermined threshold value at the determiner, for example, when the torque is not less than a torque threshold value, the supply amount controller decreases the supply amount of the material by decreasing the frequency converted by the material supply inverter. For example, when the specific gravity of the material to be pneumatically converted is heavy or when the conveyance amount of the material to be pneumatically conveyed is too much, the pipe resistance is high, so that the detected torque of the electric motor is increased to be not less than the torque threshold value. Therefore, in order to decrease the pipe resistance, the supply amount of the material is decreased by decreasing the frequency converted by the material supply inverter. By doing this, the mixing ratio μ is decreased to prevent the material density from being too high, so that the material can be pneumatically conveyed under a condition where the pipe resistance is decreased.

Moreover, since control can be performed so that the torque does not become not less than the threshold value by decreasing the supply amount of the material even when the torque is not less than the torque threshold value, a conventionally required protective device of the suction air source such as a thermal relay that interrupts current or a safety valve for decreasing pressure can be kept from operating. In addition, since control can be performed so that the torque does not become not less than the threshold value, the output of the electric motor of the suction air source can be used at the maximum, so that it is unnecessary to provide a conventionally provided electric motor or suction air source of an excessive rated capacity allowing leeway and this enables power saving.

In the ninth aspect of the invention, when the physical quantity is not less than the predetermined threshold value at the determiner, the notifier provides a notification to that effect. Consequently, even if the torque of the electric motor becomes not less than the torque threshold value, that condition can be detected quickly.

In the tenth aspect of the invention, the consumption amount calculator calculates the consumption amount of the material. The consumption amount of the material is, for example, the processing capacity of the molding machine or the like, and indicates how much material is consumed per unit time. The supply amount controller controls the supply amount of the material by controlling the frequency converted by the material supply inverter, according to the consumption amount calculated by the consumption amount calculator. Consequently, even when there is a change of a material request at a downstream process such as the molding machine, the material responsive to the request change can be pneumatically conveyed.

In the eleventh aspect of the invention, the controller controls, in order that the mixing ratio of the material is within the required range, the air volume or the air speed by the suction air source by controlling the frequency converted by the inverter, according to the supply amount of the material. While the mixing ratio μ is maintained within the required range, when the supply amount W of the material is increased in response to a material request at a downstream process (for example, the molding machine), the air volume or the air speed of the suction air source is increased by increasing the frequency converted by the inverter. When the supply amount W of the material is decreased in response to a material request at a downstream process (for example, the molding machine), the mixing ratio μ is maintained within the required range by decreasing the air volume or the air speed by the suction air source by decreasing the frequency converted by the inverter. By doing this, the set mixing ratio can be maintained even when the capacity of pneumatic conveyance of the material is changed according to a change of a request at the downstream process.

In the twelfth aspect of the invention, the controller controls, in order that the air volume or the air speed by the suction air source is within the required range, the frequency converted by the inverter, according to the supply amount of the material. Even when the supply amount W of the material is increased or decreased in response to a material request at a downstream process (for example, the molding machine), the air volume or the air speed by the suction air source is maintained within the required range by controlling the frequency converted by the inverter. By doing this, the set air volume or air speed can be maintained even when the capacity of pneumatic conveyance of the material is changed according to a change of a request at the downstream process.

In the thirteenth aspect of the invention, the following are provided: the accommodation portion that captures and accommodates the material conveyed through the pipe; and the first detector for detecting the material supply start time point and the second detector for detecting the material supply stop time point which the first and the second detectors are provided at different positions of the accommodation portion. The accommodation portion is, for example, a collector, and the first detector and the second detector are a level meter provided at a lower part of the collector and a level meter provided at an upper part thereof, respectively. For example, in a case where the material is used at the molding machine connected to the collector, when the material level in the collector is decreased and the level of the material reaches the detection position of the lower level meter (first detector), a material supply start request signal is output. When the material is pneumatically conveyed and the level of the material reaches the detection position of the upper level meter (second detector), a material supply stop request signal is output. When the time difference between the supply start time point t1 and the supply end time point t2 is Δt and the amount of material accommodated between the first detector and the second detector of the collector is Y, the consumption amount of the material can be calculated by Y/Δt. Consequently, the material processing capacity, that is, the consumption amount at the downstream process can be calculated with a simple structure.

According to the present invention, stagnation or quality degradation of the material is prevented to allow pneumatic conveyance of a material to be performed under an optimum condition.

The above and further objects and features of the invention will more fully be apparent from the following detailed description with accompanying drawings.

### BRIEF DESCRIPTION OF THE SEVERAL VIEWS OF THE DRAWING

FIG. 1 is an explanatory view showing an example of the structure of a material conveyance device of the present embodiment.

FIG. 2 is a schematic view showing an example of the pressure/air volume characteristic of a suction air source.

FIG. 3 is a schematic view showing an example of the air volume/rotation number characteristic of the suction air source.

FIG. 4 is an explanatory view showing an example of the output characteristic of an inverter-controlled motor of the present embodiment.

FIG. 5 is a schematic view showing an example of the relationship between the air volume by the suction air source and the frequency of the inverter.

FIG. 6 is a schematic view showing an example of the relationship between the pressure and the air volume by the suction air source.

FIG. 7 is a schematic view showing an example of the torque curve of the inverter-controlled motor.

FIG. 8 is a schematic view showing an example of the torque curve of the inverter-controlled motor.

FIG. 9 is a schematic view showing another example of the relationship between the air volume by the suction air source and the frequency of the inverter.

FIG. 10 is a schematic view showing another example of the relationship between the pressure and the air volume by the suction air source.

FIG. 11 is a schematic view showing another example of the torque curve of the inverter-controlled motor.

FIG. 12 is a schematic view showing another example of the torque curve of the inverter-controlled motor.

FIG. 13 is an explanatory view showing an example of the relationship between the torque ratio of the motor and the pressure by the suction air source.

FIG. 14 is an explanatory view showing an example of the conveyance form of pneumatic conveyance.

FIG. 15 is a schematic view showing an example of the difference in pressure/air volume characteristic according to the kind of the suction air source.

### DETAILED DESCRIPTION

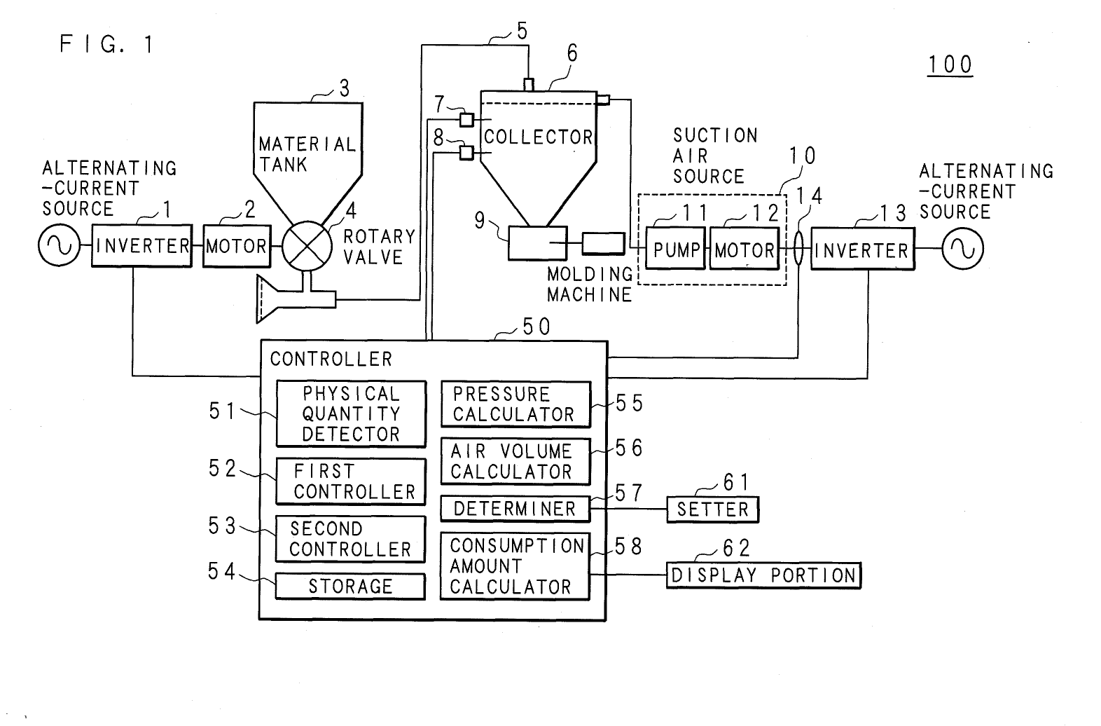

Hereinafter, the present invention will be described based on the drawings showing an embodiment thereof. FIG. 1 is an explanatory view showing an example of the structure of a material conveyance device 100 of the present embodiment. As shown in FIG. 1, the material conveyance device 100 includes an inverter 1 as the material supply inverter, a motor 2, a material tank 3, a rotary valve 4, a collector 6 as the accommodation portion, a suction air source 10, an inverter 13, and a controller 50. The suction air source 10 has a pump 11 and a motor 12 as the electric motor. The material tank 3, the motor 2 and the rotary valve 4 as the material container constitute the material supply portion. The outlet of the rotary valve 4 provided below the material tank 3 and the collector 6 are interconnected by a pipe 5 for pneumatically conveying a material (for example, a powder and granular material). A molding machine 9 is provided at the outlet of the collector 6.

A level meter 8 as the first detector for detecting the material supply start time point is provided at a lower part of the collector 6, and a level meter 7 as the second detector for detecting the material supply stop time point is provided at an upper part of the collector 6.

The controller 50 includes: a physical quantity detector 51 that detects a physical quantity related to the output of the inverter 13; a first controller 52 as the controller that controls the air volume or the air speed by the suction air source 10; a second controller 53 as the supply amount controller that controls the supply amount of the material; a storage 54 that stores predetermined information; a pressure calculator 55 that calculates the pressure by the suction air source 10; an air volume calculator 56 that calculates the air volume or the air speed by the suction air source 10; a determiner 57 that determines whether the physical quantity detected by the physical quantity detector 51 is not less than a predetermined threshold value or not; and a consumption amount calculator 58 that calculates the consumption amount of the material at the molding machine 9, that is, the processing capacity of the molding machine 9. Moreover, a setter 61 and a display portion 62 are connected to the controller 50.

The rotary valve 4 is structured, for example, as follows: A plurality of material containers (not shown) are appropriately arranged, the rotary shaft of the motor 2 rotates to thereby admit a predetermined amount of material into the material containers from the material tank 3, the material containers accommodating the material rotate in order, and the material accommodated in the material containers is discharged into the pipe 5 at a predetermined position.

The inverter 1 converts the frequency (base frequency) of the alternating-current source supplied from a commercial power supply of 50 Hz, 60 Hz or the like, and outputs the AC voltage of the converted frequency to the motor 2. The inverter 1 is capable of adjusting the supply amount of the material by changing the number of rotations of the rotary shaft of the motor 2 according to the converted frequency to thereby adjust the number of rotations of the material containers of the rotary valve 4.

The material supplied from the rotary valve 4 to the pipe 5 is pneumatically conveyed to the collector 6 through the pipe 5 by the suction force by the suction air source 10. That is, the suction air source 10 causes an air current in the pipe 5 by a negative pressure, and the material is conveyed in the pipe 5 by the air current. The pneumatically conveyed material is separated into the material and air by a filter (in the figure, the member shown by the broken line) in the collector 6, the separated material is accommodated in the collector 6, and the separated air is discharged to the outside through the suction air source 10. The fine powder contained in the air separated in the collector 6 is captured by a non-illustrated fine powder filter, and the air from which the fine powder has been removed is discharged. The material accommodated in the collector 6 is consumed at the molding machine 9 as a downstream process.

As the material consumed at the molding machine 9, various ones are used according to the kind of the molded item; for example, materials of different specific gravities or materials of different physical properties are pneumatically conveyed.

The inverter 13 converts the frequency (base frequency) of the alternating-current source supplied from a commercial power supply of 50 Hz, 60 Hz or the like, and outputs an AC voltage of the converted frequency to the motor 12 of the pump 11 of the suction air source 10.

The pump 11 is a so-called vacuum pump, and various ones may be used according to the required negative pressure or vacuum degree. The required negative pressure is, for example, approximately −20 kPa to −70 kPa, and a high-vacuum pump, a normal vacuum pump or a low-vacuum pump may be used according to the negative pressure. When the air volume is more important than the negative pressure, a blower may be used instead of the pump 11. That is, the suction air source 10 is provided with a vacuum pump or a blower.

The physical quantity detector 51 detects the physical quantity related to the output of the inverter 13. The physical quantity related to the output of the inverter 13 is, for example, the torque, the current (for example, the torque current) or the output power (power) of the motor 12. The torque includes a torque ratio (dimensionless one) which is a value obtained by dividing the actual torque by a rated torque (fixed value specific to the motor 12). In the present embodiment, the torque of the motor 12 may include a current (torque current, load current, etc.) that can be converted to the torque of the motor 12 or the output power of the motor 12. That is, the torque of the motor 12 may include not only the torque of the motor 12 but also the torque current or the load current of the motor 12, or the output power of the motor 12.

The physical quantity detector 51 is capable of obtaining the torque of the motor 12 by the output current outputted to the motor 12. More specifically, since the output current of the inverter 13 is the sum of a torque current (active current) component according to the torque of the motor 12 and a reactive current component not contributing to the torque, the torque of the motor 12 can be obtained based on the torque current which is the output current from which the reactive current component is subtracted.

By detecting at least one of the torque, the current (for example, torque current) and the power (output power) of the motor 12 by the physical quantity detector 51, feedback for controlling the frequency converted by the inverter 13 can be performed.

The physical quantity detector 51 may have a structure in which the physical quantity is detected by a sensor (not shown) inside the inverter 13, or a sensor 14 may be provided between the inverter 13 and the motor 12 so that the physical quantity is detected by the sensor 14 provided outside the inverter 13. That is, the physical quantity detector 51 may be provided inside the inverter 13 or the sensor 14 may be provided on the side of the motor 12 for the detection.

The relationship between the frequency converted by the inverter 13 and the number of rotations (referred to also as “rotation speed”) of the rotary shaft of the motor 12 can be expressed as Vf=120×F/S. Here, Vf is the number of rotations of the rotary shaft of the motor 12, S is the number of poles of the motor 12, and F is the frequency of the inverter 13. For example, when the motor 12 is tetrapolar and the frequency F of the inverter 13 is 50 Hz, the number of rotations Vf of the rotary shaft of the motor 12 is 1500 rpm, and when the frequency F of the inverter 13 is 60 Hz, the number of rotations Vf of the rotary shaft of the motor 12 is 1800 rpm.

The first controller 52 controls the air volume or the air speed by the suction air source 10 based on the physical quantity detected by the physical quantity detector 51. When the air volume of the air moving in the pipe 5 is Q, the air speed thereof is S and the internal diameter of the pipe is d, S=Q(π×d²/4) holds. The torque of the motor 12 and the pressure or the pipe resistance in the pipe 5 are proportional to each other. The pressure/air volume characteristic representative of the relationship between the pressure (negative pressure) and the air volume of the suction air source 10 may be obtained in advance. The air volume Q in the pipe 5 is proportional to the number of rotations of the rotary shaft of the motor 12 of the suction air source 10, that is, the frequency converted by the inverter 13. Consequently, by controlling the frequency converted by the inverter 13 so as to increase or decrease, the air volume in the pipe 5 can be made an optimum value on the pressure/air volume characteristic of the suction air source 10. Consequently, the air volume or the air speed in the pipe 5 is prevented from being too low or being too high to prevent stagnation of the material and prevent quality degradation by preventing snaking or whiskers from occurring on the material, so that pneumatic conveyance of the material can be performed under an optimum condition.

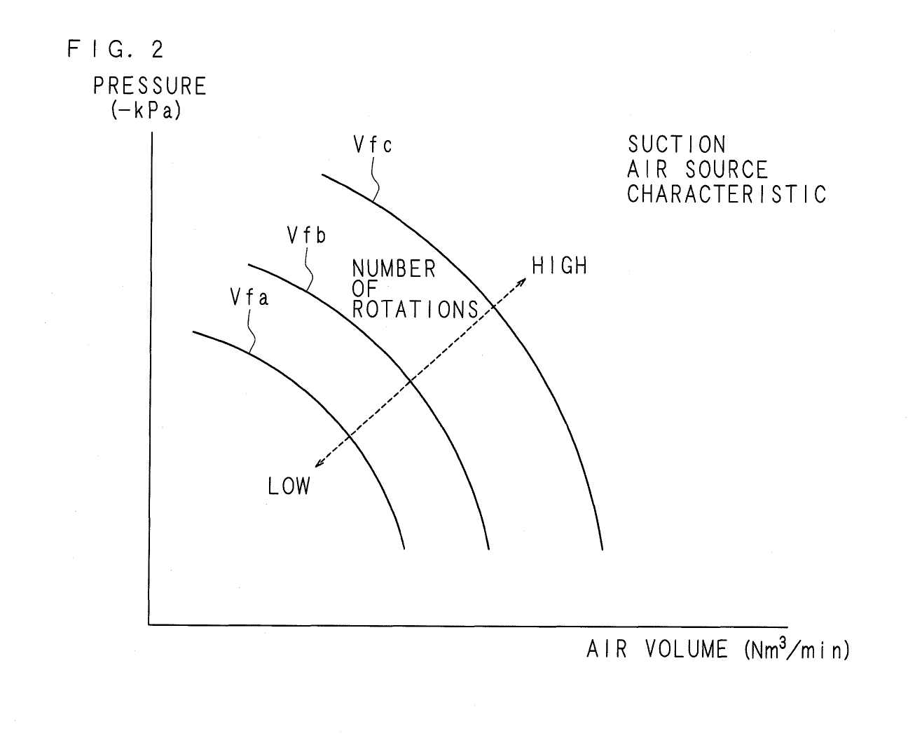

FIG. 2 is a schematic view showing an example of the pressure/air volume characteristic of the suction air source 10. In FIG. 2, the horizontal axis represents the air volume (Nm³/min), and the vertical axis represents the pressure (−kPa). When the vacuum degree in the pipe 5 is increased by the pump 11 (vacuum pump) of the suction air source 10, the pressure in the pipe 5 becomes negative, so that the air in the pipe 5 is sucked. The pressure of the suction air source 10 is equal to the pipe resistance. As shown in FIG. 2, when the pipe resistance increases, that is, when the pressure increases, the air volume decreases.

The pressure/air volume characteristic of the suction air source 10 changes according to the number of rotations of the rotary shaft of the motor 12 of the suction air source 10. As shown in FIG. 2, as the number of rotations of the rotary shaft of the motor 12 increases to Vfa, Vfb and Vfc, the curved line representative of the pressure/air volume characteristic is farther away from the origin point and changes so that the pressure and the air volume are higher values. The curved lines of the pressure/air volume characteristic shown in FIG. 2 are schematic representations, and the curved line representative of the actual pressure/air volume characteristic differs depending on the kind of the pump 11 or the blower used in the suction air source 10. That is, the curved lines representative of the pressure/air volume characteristic are not limited to the ones illustrated in FIG. 2.

It may be performed to obtain the pressure/air volume characteristic of the suction air source 10 by a measurement in advance and store the pressure value and the air volume value on the pressure/air volume characteristic in the storage 54. By doing this, the air volume can be obtained if the pressure is found. Alternatively, it may be performed to obtain an expression (including an approximate expression) representative of the pressure/air volume characteristic of the suction air source 10 and calculate the air volume from the pressure by an operation by use of the expression, or it may be performed to calculate the pressure from the air volume by an operation.

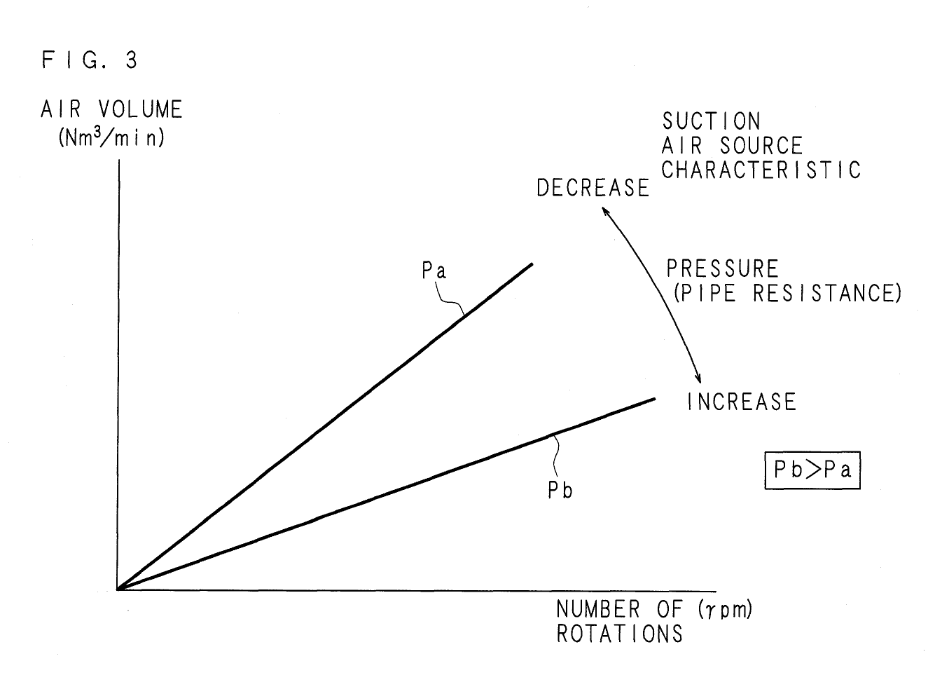

FIG. 3 is a schematic view showing an example of the air volume/rotation number characteristic of the suction air source 10. In FIG. 3, the horizontal axis represents the number of rotations (rpm) of the rotary shaft of the motor 12, and the vertical axis represents the air volume (Nm³/min). As shown in FIG. 3, the air volume by the suction air source 10 is proportional to the number of rotations of the rotary shaft of the motor 12, that is, the frequency converted by the inverter 13. That is, between the number of rotations Vf of the rotary shaft of the motor 12 and the air volume Q by the suction air source 10, a relationship of the air volume Q being proportional to the number of rotations Vf(Q∝Vf) holds.

Moreover, the air volume/rotation number characteristic of the suction air source 10 changes according to the pipe resistance, that is, the pressure (negative pressure) in the pipe 5. As shown in FIG. 3, as the pressure by the suction air source 10 increases (becomes higher) to Pa and Pb, the straight line representative of the air volume/rotation number characteristic (approximation straight line, that is, including a characteristic approximated to a straight lines) is situated lower in the figure. The straight lines representative of the relationship between the air volume and the number of rotations shown in FIG. 3 are schematic representations, and the straight line representative of the actual air volume/rotation number characteristic differs depending on the kind of the pump 11 or the blower used in the suction air source 10. That is, the straight line or the approximation straight line representative of the air volume/rotation number characteristic is not limited to the ones illustrated in FIG. 3. Moreover, the difference in air volume/rotation number characteristic according to the magnitude of the pressure is a schematic representation, and is not limited to the example of FIG. 3.

As is apparent from FIG. 3, to increase the air volume by the suction air source 10, control is performed so that the frequency of the inverter 13 is increased, and to decrease the air volume by the suction air source 10, control is performed so that the frequency of the inverter 13 is decreased.

As described above, the first controller 52 controls the air volume or the air speed by the suction air source 10 by controlling the frequency converted by the inverter 13. Between the rotation speed of the rotary shaft of the motor 12 of the suction air source 10 and the air volume by the suction air source 10, a relationship of the air volume being proportional to the rotation speed holds. Since the rotation speed of the rotary shaft of the motor 12 is proportional to the frequency converted by the inverter 13, the air volume or the air speed by the suction air source 10 is proportional to the frequency converted by the inverter 13. Therefore, by controlling the frequency of the inverter 13, the air volume or the air speed can be controlled, and at the same time, the pressure (negative pressure) of the air can be controlled according to the pressure/air volume characteristic of the suction air source 10.

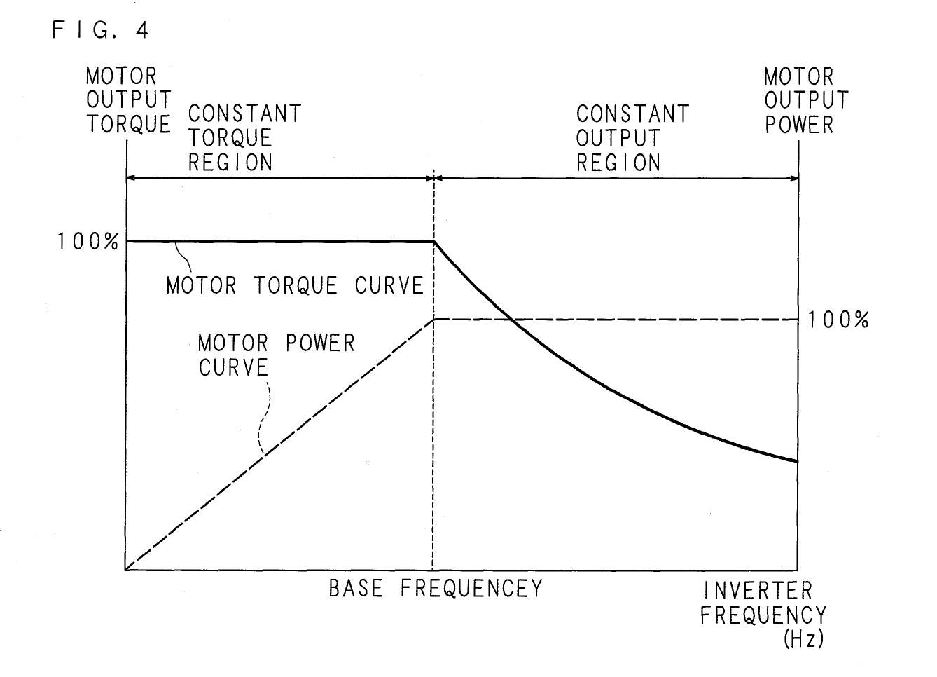

FIG. 4 is an explanatory view showing an example of the output characteristic of the inverter-controlled motor of the present embodiment. In FIG. 4, the horizontal axis represents the frequency of the inverter 13, and the vertical axis represents the torque (output torque) and the output power of the motor 12. As shown in FIG. 4, the output characteristic of the motor 12 changes when the frequency of the inverter 13 goes beyond the base frequency (for example, 50 Hz or 60 Hz). At the frequencies not more than the base frequency, the output characteristic is a constant torque characteristic, and at the frequencies not less than the base frequency, it is a constant output characteristic.

In FIG. 4, like the torque curve (torque characteristic) of the motor 12 shown by the solid line, in the constant torque region, the torque of the motor 12 is constant, and in the constant output region, it gradually decreases as the frequency of the inverter 13 increases. The output power of the motor is constant on the torque curve of the motor 12 in the constant output region.

Moreover, in FIG. 4, like the power curve (output power characteristic) of the motor 12 shown by the broken line, in the constant torque region, the output power of the motor 12 gradually increases as the frequency of the inverter 13 increases, and in the constant output region, it is constant. The torque of the motor 12 is constant on the power curve of the motor 12 in the constant torque region.

The pressure calculator 55 calculates the pressure by the suction air source 10 based on the physical quantity detected by the physical quantity detector 51. When the detected physical quantity is, for example, the torque T of the motor 12 and the pressure by the suction air source 10 is P, the pressure can be calculated by an expression P=c×T+d. Here, the constants c and d are determined by the specifications or the like of the suction air source 10.

The air volume calculator 56 calculates the air volume by the suction air source 10 based on the pressure calculated by the pressure calculator 55 and the pressure/air volume characteristic representative of the relationship between the pressure and the air volume of the suction air source 10. The pressure/air volume characteristic may be stored in the storage 54 as mentioned above, or a relational expression representative of the pressure/air volume characteristic is determined. Moreover, using a relational expression S=Q/(π×d²/4) among the air volume Q, the air speed S and the internal diameter d of the pipe 5, the air speed can be calculated from the calculated air volume.

One important parameter in managing whether pneumatic conveyance of the material is performed normally or not is the air speed (or the air volume) in the pipe 5. Although it depends also on the characteristic or the specific gravity of the material, in order that the material does not become stagnant in the pipe 5 and that the material does not rub in the pipe 5 to cause quality degradation, it is necessary that the required air speed be, for example, in a range of 20 m/s to 24 m/s. Moreover, if the internal diameter d of the pipe 5 is found, the required air speed can also be obtained.

The first controller 52 controls the frequency, converted by the inverter 13, so that the air volume or the air speed calculated by the air volume calculator 56 is within a required range. That is, by presetting an optimum required range of the air volume or the air speed where no material stagnation or material quality degradation is caused, the first controller 52 controls the frequency, converted by the inverter 13, so that the air volume or the air speed calculated by the air volume calculator 56 is within the required range. Consequently, stagnation or quality degradation of the material is prevented to allow pneumatic conveyance of the material to be performed under an optimum condition.

Next, a method of controlling the air volume or the air speed in the pipe 5 so as to be within the optimum range will be concretely described. First, a case will be described in which the air volume (air speed) is decreased since the air volume (air speed) in the pipe 5 exceeds the required range because of a factor such as a change of the material or a change of the material consumption amount at the molding machine 9 as a downstream process.

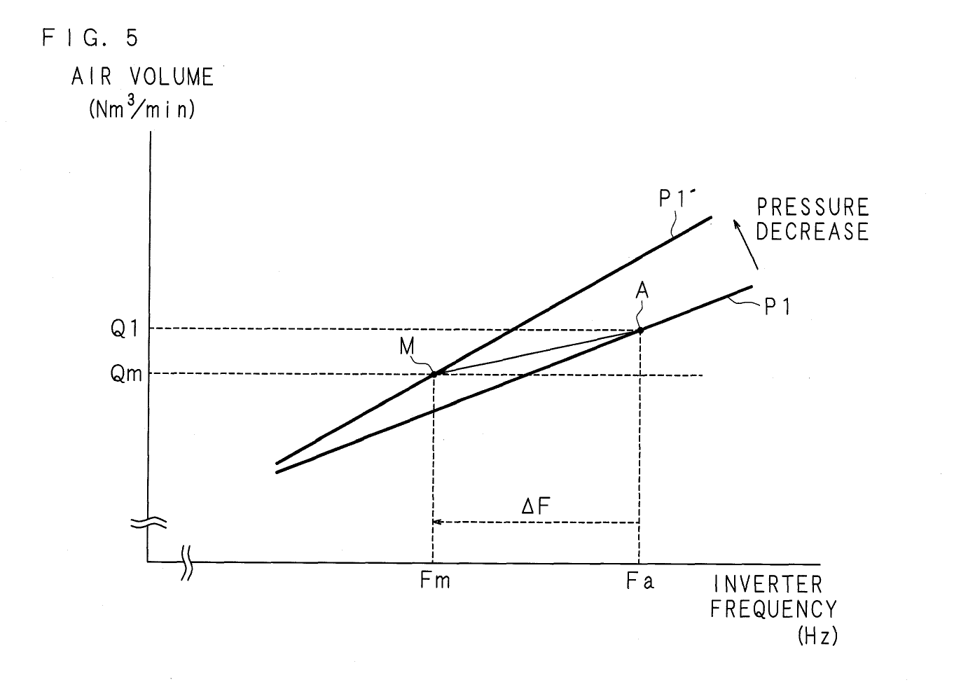

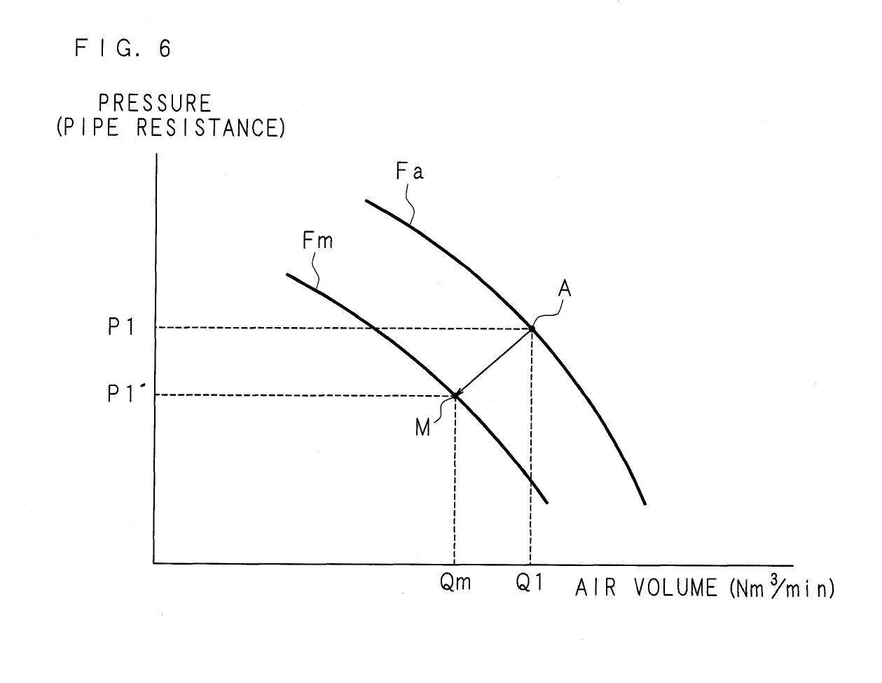

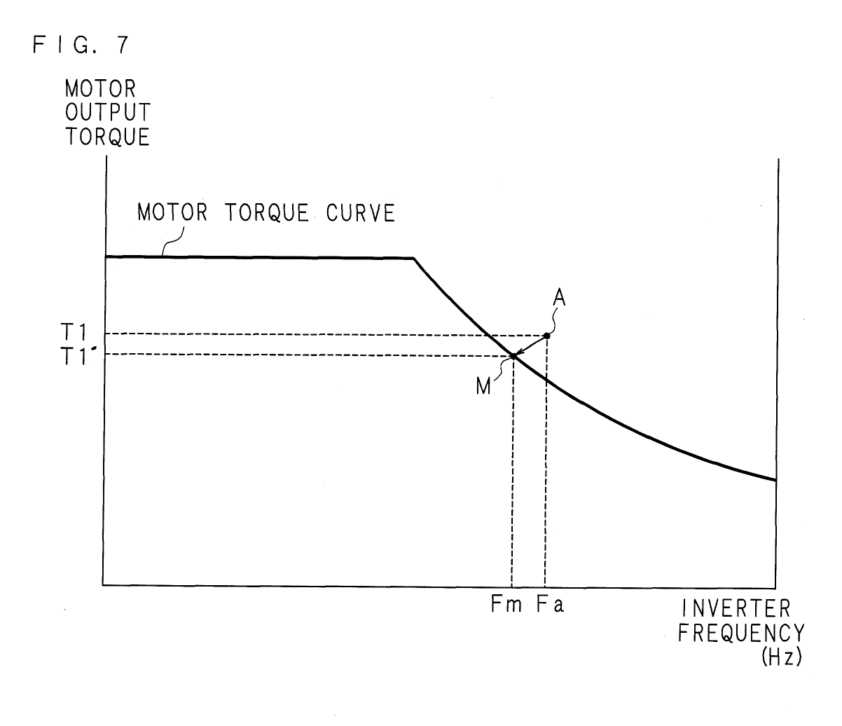

FIG. 5 is a schematic view showing an example of the relationship between the air volume by the suction air source 10 and the frequency of the inverter 13, FIG. 6 is a schematic view showing an example of the relationship between the pressure and the air volume by the suction air source 10, and FIG. 7 is a schematic view showing an example of the torque curve of the inverter-controlled motor 12. In FIG. 5, it is assumed that pneumatic conveyance of the material is performed at the point denoted by reference numeral A, that is, when the frequency of the inverter 13 is Fa, the air volume is Q1 and the pressure is P1. Here, the required air volume is Qm. While the required air volume is Qm here for simplicity, a range delimited by an upper limit and a lower limit may be the required range. As examples of the numerical values on the straight lines illustrated in FIG. 5, for example, when the pressure is −14 kPa and the motor output is 1 kW, the air speed when the frequency is 60 Hz is 11 m/s, and the air speed when the frequency is 75 Hz is 32 m/s; however, the present invention is not limited thereto.

Moreover, the operation condition shown by reference numeral A of FIG. 5 can be represented by a point denoted by reference numeral A in FIG. 6. That is, operation is performed under a condition shown by a point, where the pressure is P1 and the air volume is Q1, on the pressure/air volume characteristic when the frequency of the inverter 13 (corresponding to the number of rotations of the rotary shaft of the motor 12) is Fa.

Moreover, the operation condition denoted by reference numeral A of FIG. 5 can be represented, for example, by a point denoted by reference numeral A in FIG. 7. That is, operation is performed under a condition, where the frequency of the inverter 13 is Fa, shown by the torque T1 corresponding to the pressure P1.

As shown in FIG. 5, in order to change the air volume to a required air volume Qm from a condition where operation is performed at the air volume Q1 (>Qm), the frequency of the inverter 13 is decreased from Fa to Fm by ΔF. Consequently, the operation condition is shifted to a point denoted by reference numeral M, that is, a condition where the frequency of the inverter 13 is Fm and the air volume is Qm.

By decreasing the frequency of the inverter 13 from Fa to Fm, as shown in FIG. 6, the pressure and the air volume of the suction air source 10 shift from the pressure/air volume characteristic corresponding to the frequency Fa onto the pressure/air volume characteristic corresponding to the frequency Fm. The operation condition at the air speed Q1 shown by reference numeral A on the pressure/air volume characteristic corresponding to the frequency Fa becomes the operation condition at the air volume Qm shown by reference numeral M on the pressure/air volume characteristic corresponding to the frequency Fm. At this time, the pressure (pipe resistance) decreases from the pressure P1 to the pressure P1′.

By decreasing the frequency of the inverter 13 from Fa to Fm, although the air volume can be decreased from Q1 to Qm, the pressure is decreased from P1 to P1′ at the same time, so that as shown in FIG. 5, the operation condition shown by reference numeral M is on the straight line representative of the relationship between the air volume and the number of rotations (frequency) at the pressure P1′.

Moreover, as shown in FIG. 7, by decreasing the frequency of the inverter 13 from Fa to Fm, the pressure is decreased from P1 to P1′, so that the torque of the motor 12 proportional to the pressure is also decreased from T1 to T1′. The torque curve of the motor shown in FIG. 7 is, for example, a torque curve (for example, at the time of 100% of the rating) which is the range of use of the motor 12 and where use at the maximum capacity is possible. The torque curve of the motor 12 is not limited to the torque curve where the maximum capacity is delivered, but may be 95% or 90% of the rating or may be 105%, 110% or the like exceeding the rating. By using the motor 12 on the torque curve when operation is performed with a required air volume in advance, the motor 12 can be used at the maximum capacity.

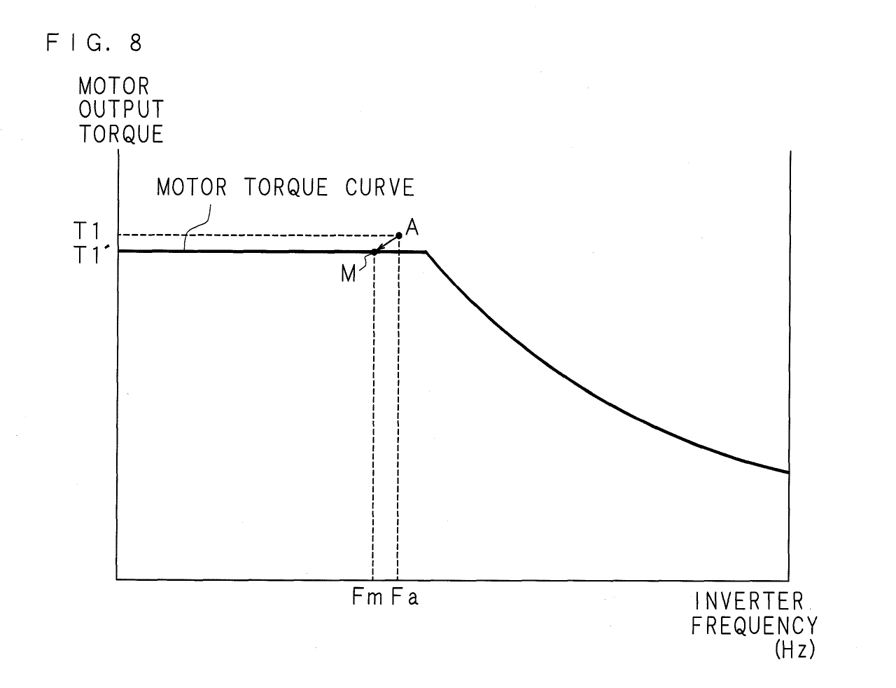

While in the example of FIG. 7, the operation condition of the inverter-controlled motor 12 is a so-called constant output region, the present invention is not limited thereto. FIG. 8 is a schematic view showing an example of the torque curve of the inverter-controlled motor 12. In the example of FIG. 8, the operation condition of the inverter-controlled motor 12 is a so-called constant torque region. Also in this case, by decreasing the frequency of the inverter 13 from Fa to Fm, the pressure is decreased from P1 to P1′, so that the torque of the motor 12 proportional to the pressure is also decreased from T1 to T1′.

Next, a case will be described in which the air volume (air speed) is increased since the air volume (air speed) in the pipe 5 is below the required range because of a factor such as a change of the material or a change of the material consumption amount at the molding machine 9 as a downstream process.

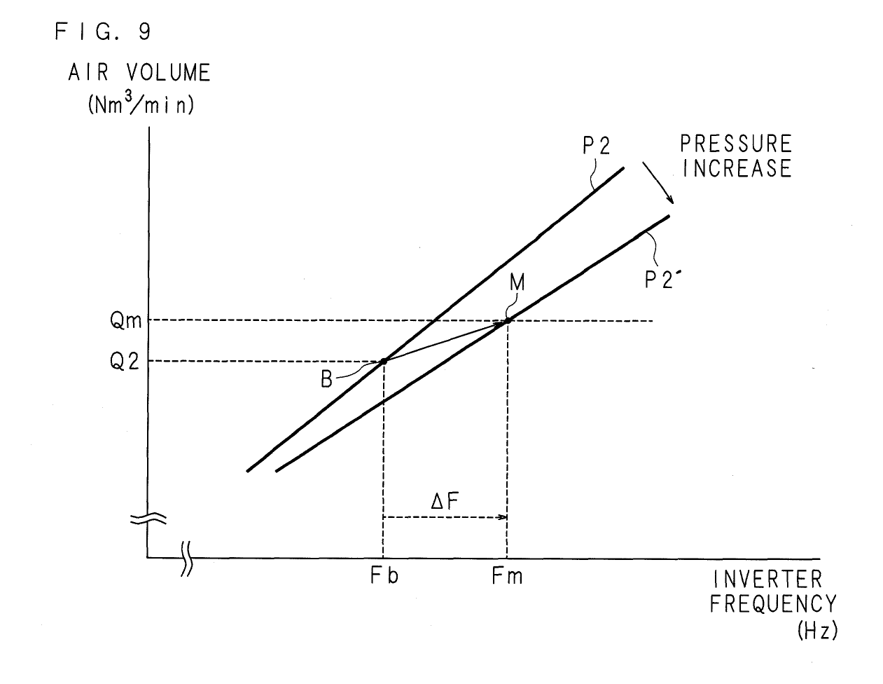

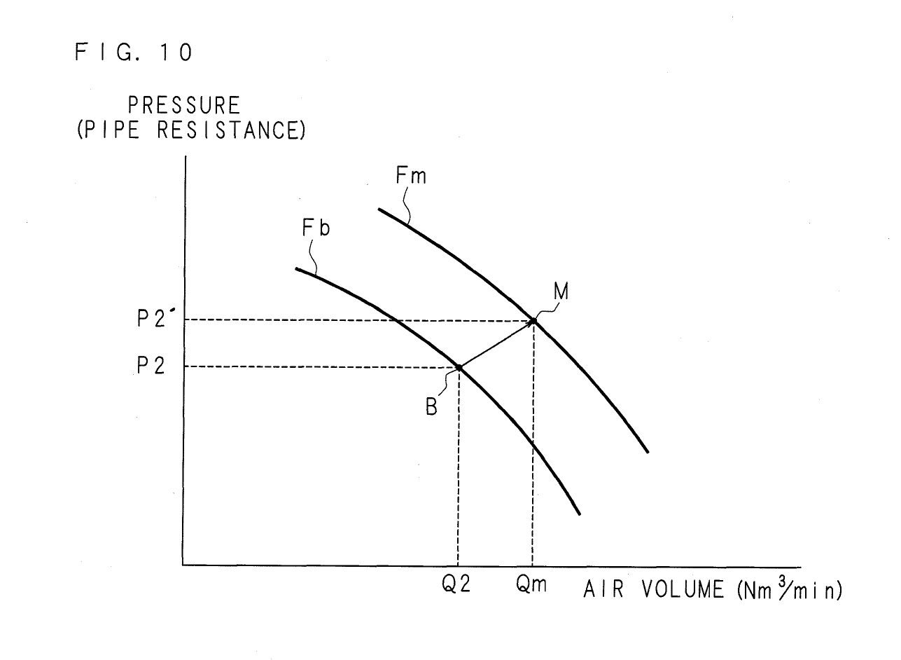

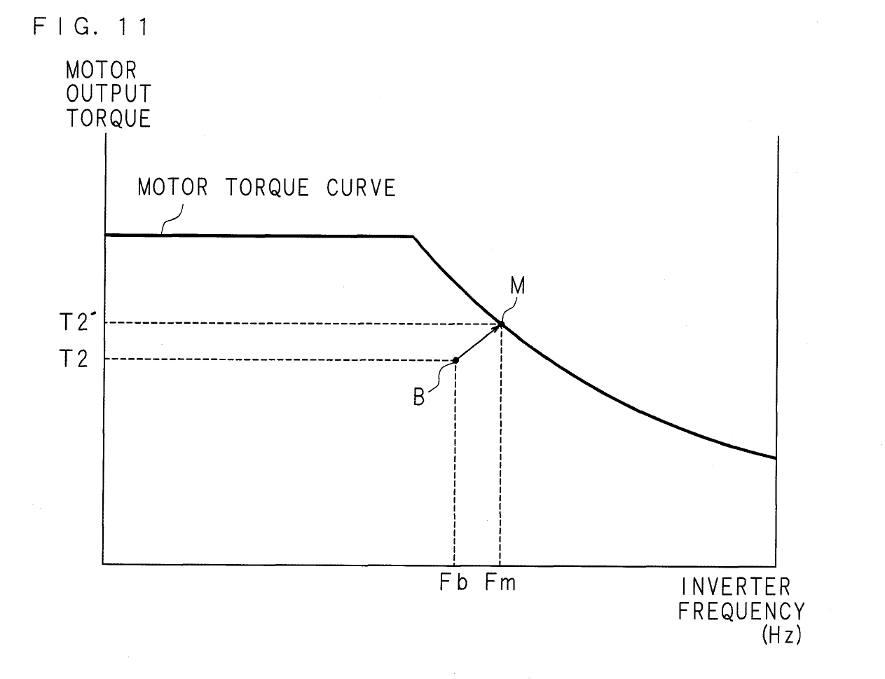

FIG. 9 is a schematic view showing another example of the relationship between the air volume by the suction air source 10 and the frequency of the inverter 13, FIG. 10 is a schematic view showing another example of the relationship between the pressure and the air volume by the suction air source 10, and FIG. 11 is a schematic view showing another example of the torque curve of the inverter-controlled motor 12. In FIG. 9, it is assumed that pneumatic conveyance of the material is performed at the point denoted by reference numeral B, that is, when the frequency of the inverter 13 is Fb, the air volume is Q2 and the pressure is P2. Here, the required air volume is Qm. While the required air volume is Qm here for simplicity, a range delimited by an upper limit and a lower limit may be the required range.

Moreover, the operation condition shown by reference numeral B of FIG. 9 can be represented by a point denoted by reference numeral B in FIG. 10. That is, operation is performed under a condition shown by a point, where the pressure is P2 and the air volume is Q2, on the pressure/air volume characteristic when the frequency of the inverter 13 (corresponding to the number of rotations of the rotary shaft of the motor 12) is Fb.

Moreover, the operation condition shown by reference numeral B of FIG. 9 can be represented, for example, by a point denoted by reference numeral B in FIG. 11. That is, operation is performed under a condition, where the frequency of the inverter 13 is Fb, shown by the torque T2 corresponding to the pressure P2.

As shown in FIG. 9, in order to change the air volume to the required air volume Qm from a condition where operation is performed at the air volume Q2 (<Qm), the frequency of the inverter 13 is increased from Fb to Fm by AF. Consequently, the operation condition is shifted to a point denoted by reference numeral M, that is, a condition where the frequency of the inverter 13 is Fm and the air volume is Qm.

By increasing the frequency of the inverter 13 from Fb to Fm, as shown in FIG. 10, the pressure and the air volume of the suction air source 10 shift from the pressure/air volume characteristic corresponding to the frequency Fb onto the pressure/air volume characteristic corresponding to the frequency Fm. The operation condition at the air speed Q2 shown by reference numeral B on the pressure/air volume characteristic corresponding to the frequency Fb becomes the operation condition at the air volume Qm shown by reference numeral M on the pressure/air volume characteristic corresponding to the frequency Fm. At this time, the pressure (pipe resistance) increases from the pressure P2 to the pressure P2′.

By increasing the frequency of the inverter 13 from Fb to Fm, although the air volume can be increased from Q2 to Qm, the pressure is increased from P2 to P2′ at the same time, so that as shown in FIG. 9, the operation condition shown by reference numeral M is on the straight line representative of the relationship between the air volume and the number of rotations (frequency) at the pressure P2′.

Moreover, as shown in FIG. 11, by increasing the frequency of the inverter 13 from Fb to Fm, the pressure is increased from P2 to P2′, so that the torque of the motor 12 proportional to the pressure is also increased from T2 to T2′. The torque curve of the motor shown in FIG. 11 is also, as in FIG. 7, for example, a torque curve (for example, at the time of 100% of the rating) which is the range of use of the motor 12 and where use at the maximum capacity is possible. The torque curve of the motor 12 is not limited to the torque curve where the maximum capacity is delivered, but may be 95% or 90% of the rating or may be 105%, 110% or the like exceeding the rating. By using the motor 12 on the torque curve when operation is performed with a required air volume in advance, the motor 12 can be used at the maximum capacity.

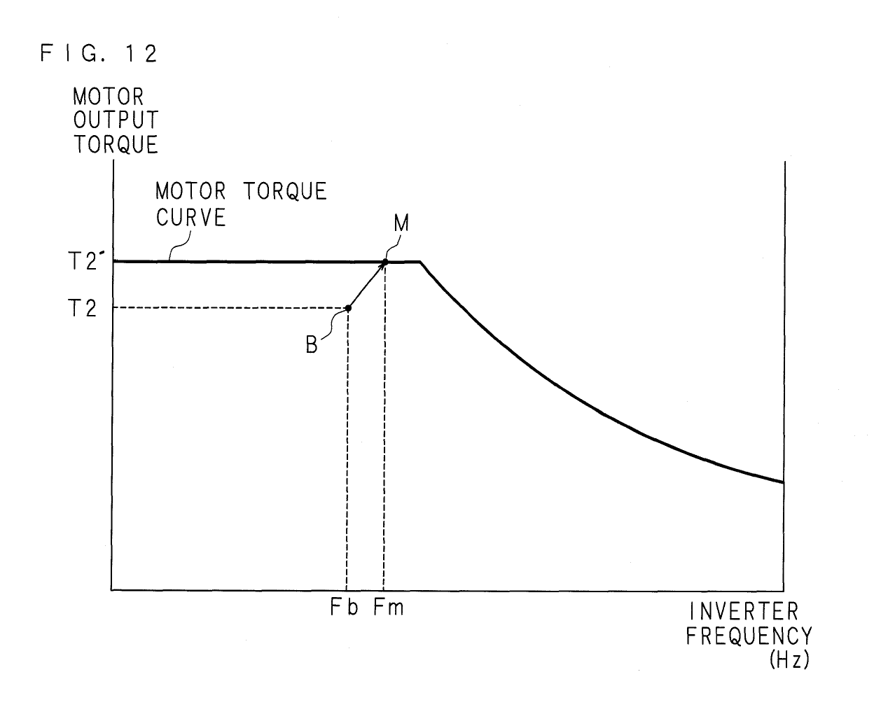

While in the example of FIG. 11, the operation condition of the inverter-controlled motor 12 is a so-called constant output region, the present invention is not limited thereto. FIG. 12 is a schematic view showing another example of the torque curve of the inverter-controlled motor 12. In the example of FIG. 12, the operation condition of the inverter-controlled motor 12 is a so-called constant torque region. Also in this case, by increasing the frequency of the inverter 13 from Fb to Fm, the pressure is increased from P2 to P2′, so that the torque of the motor 12 proportional to the pressure is also increased from T2 to T2′.

Next, display of the pressure and the air volume by the suction air source 10 of the present embodiment will be described.

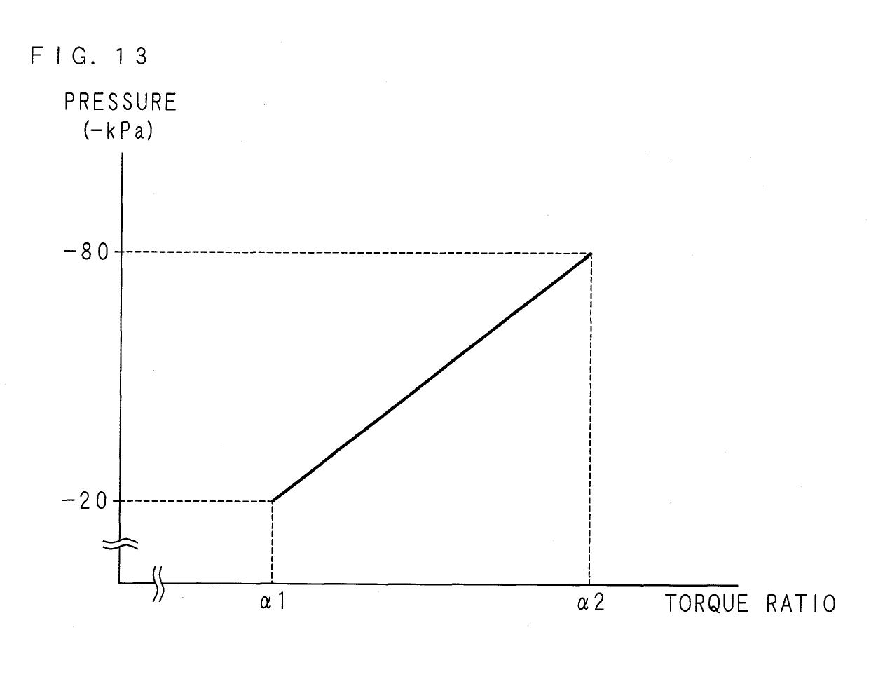

FIG. 13 is an explanatory view showing an example of the relationship between the torque ratio of the motor 12 and the pressure by the suction air source 10. The torque ratio is the actual torque divided by the rated torque (fixed value specific to the motor 12), and can be converted to torque. The pressure P by the suction air source 10 and the torque ratio R or the torque T of the motor 12 are proportional to each other. For example, it can be expressed as P=c×R+d or P=c×T+d. The straight line of FIG. 13 illustrates the relationship of P=c×R+d. Here, constants c and d are determined by the specifications or the like of the motor 12 or the like.

The example of FIG. 13 shows an example of the suction air source where the pressure is −20 kPa when the torque ratio is α1 and the pressure is −80 kPa when the torque ratio is α2. The torque ratios α1 and α2 are determined by the specifications or the like of the pump 11, the motor 12 or the like. Moreover, depending on the kind of the pump, the pressure range may be, as in FIG. 13, for example, a range such as −20 kPa to −40 kPa instead of a wide range such as −20 kPa to −80 kPa. Moreover, the relationship between the pressure and the torque ratio is not limited to the example of FIG. 13. For example, the pressure may be set such that when the motor output is 1 kW, the pressure when the torque ratio is 100 is −7 kPa and the pressure when the torque ratio is 120 is −15 kPa.

The storage 54 stores, so as to be associated with each other, the pressure values at a plurality of points on a relational expression representative of the relationship between the torque ratio or the torque of the motor 12 and the pressure by the suction air source 10 as illustrated in FIG. 13 and the torque ratio or the torque value. The pressure calculator 55 is capable of calculating the pressure by the suction air source 10 from the detected torque by using the relational expression illustrated in FIG. 13 or numerical data.

The display portion 62 has, for example, a liquid crystal panel, has the function as the pressure display portion, and displays the pressure calculated by the pressure calculator 55. Consequently, it is unnecessary to provide a pressure meter in a required location of the pipe or the like. In addition, there are no pressure measurement errors arising from the use of the pressure meter, so that the air pressure can be obtained with precision.

The display portion 62 also has the function as the air volume display portion, and displays the air volume or the air speed calculated by the air volume calculator 56. Consequently, it is unnecessary to provide an air speed meter or an air volume meter in the pipe.

The setter 61 is capable of setting parameters such as the air speed, the air volume, the mixing ratio and the material supply amount (for example, the material weight per unit time).

Next, control of the material supply side will be described. The second controller 53 has the function as the supply amount controller, and in order that the mixing ratio of the material is within a required range, controls the supply amount of the material by controlling the frequency converted by the inverter 1, according to the air volume or the air speed by the suction air source 10.

The mixing ratio is a value representative of how much material can be conveyed per unit air, and represents the ratio of the weight of the material to the weight of the air per unit time. For example, when the supply amount of the material per unit time is W and the air volume is Q, the mixing ratio μ can be expressed as μ=k×W/Q. Here, k is a constant.

When the mixing ratio μ is below a required range (for example, μ=4 to 8) in a case where control is performed at an optimum air volume Q where no stagnation or quality degradation of the material is caused, the mixing ratio μ is made within the required range by increasing the supply amount W of the material by increasing the frequency of the inverter 1. When the mixing ratio μ is higher than the required range, the mixing ratio μ is made within the required range by decreasing the supply amount W of the material by decreasing the frequency of the inverter 1. By doing this, the required material can be supplied while control is performed at the optimum air volume Q where no stagnation or quality degradation of the material is caused.

Next, a method will be described of providing the setting range of the mixing ratio or the air speed (air volume) according to the size (rated capacity) or the kind of the suction air source.

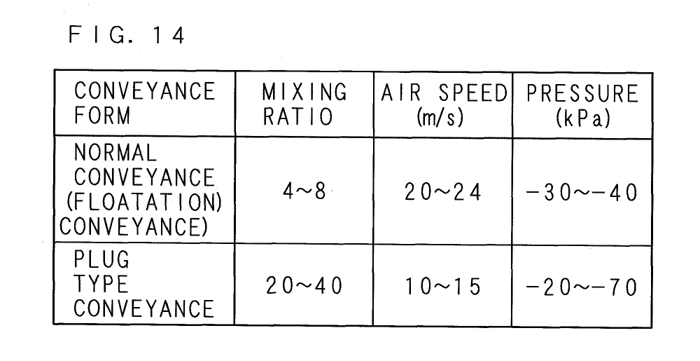

FIG. 14 is an explanatory view showing an example of the conveyance form of pneumatic conveyance. As shown in FIG. 14, examples of the conveyance form of pneumatic conveyance of the material include normal conveyance (referred to also as floatation conveyance) and plug type conveyance. The normal conveyance is a conveyance form in which the material continuously flows in a floating state in the air. On the other hand, the plug type conveyance is a conveyance form in which the material becomes clusters in a discontinuous state in the pipe, the material clusters temporarily stop in the pipe and when the pressure is increased, the stopped material clusters flow in the pipe.

As shown in FIG. 14, in the normal conveyance, for example, the required mixing ratio is 4 to 8, the required air speed is 20 m/s to 24 m/s, and the pressure at this time is −30 kPa to −40 kPa. In the plug type conveyance, for example, the required mixing ratio is 20 to 40, the required air speed is 10 m/s to 15 m/s, and the pressure at this time is −20 kPa to −70 kPa. These numerical values are examples, and the present invention is not limited thereto.

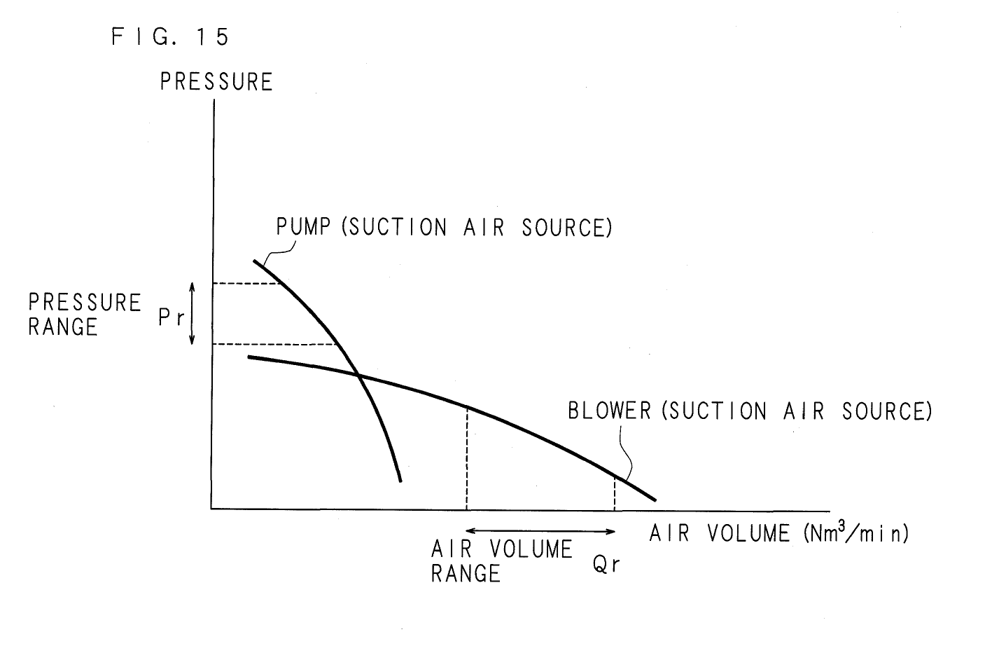

FIG. 15 is a schematic view showing an example of the difference in pressure/air volume characteristic according to the kind of the suction air source. When the suction air source is provided with a pump (for example, a vacuum pump), the pressure/air volume characteristic of the suction air source is such that the pressure is comparatively high and the air volume is comparatively small as shown in FIG. 15. On the other hand, when the suction air source is provided with a blower, the pressure/air volume characteristic of the suction air source is such that the pressure is comparatively low and the air volume is comparatively large as shown in FIG. 15. Thus, the set air volume or air pressure differs depending on the kind of the suction air source, and when the supply amount of the material is changed, the mixing ratio is also changed. Therefore, it is important to perform operation under a condition where the air volume or the air speed and the mixing ratio are set in the required range.

First, a case will be described in which setting is made by the setter 61 so that the mixing ratio is within the required range. The first controller 52 controls, in order that the mixing ratio of the material is within the required range, the air volume or the air speed by the suction air source 10 by controlling the frequency converted by the inverter 13, according to the supply amount of the material. For example, when the supply amount W of the material is increased in response to a material request at a downstream process (for example, the molding machine), the mixing ratio μ is maintained within the required range by increasing the air volume or the air speed by the suction air source 10 by increasing the frequency converted by the inverter 13. Since the mixing ratio μ is such that the mixing ratio μ the supply amount W/the air volume Q as mentioned above, the mixing ratio μ can be made constant by increasing the air volume Q by the amount of increase of the supply amount W.

When the supply amount W of the material is decreased in response to a material request at a downstream process (for example, the molding machine), the mixing ratio μ is maintained within the required range by decreasing the air volume or the air speed by the suction air source 10 by decreasing the frequency converted by the inverter 13. By doing this, the set mixing ratio can be maintained even when the capacity of pneumatic conveyance of the material is changed according to a change of a request at the downstream process.

Next, a case will be described in which setting is made by the setter 61 so that the air speed or the air volume is within the required range. The first controller 52 controls, in order that the air volume or the air speed by the suction air source 10 is within the required range, the frequency converted by the inverter 13, according to the supply amount of the material. Even when the supply amount W of the material is increased or decreased in response to a material request at a downstream process (for example, the molding machine), the air volume or the air speed by the suction air source 10 is maintained within the required range by controlling the frequency converted by the inverter 13. By doing this, the set air volume or air speed can be maintained even when the capacity of pneumatic conveyance of the material is changed according to a change of a request at the downstream process.

The determiner 57 determines whether the physical quantity detected by the physical quantity detector 51 is not less than a predetermined threshold value or not. The physical quantity is, for example, the torque of the motor 12.

When the determiner 57 determines that the physical quantity is not less than the predetermined threshold value, for example, that the torque is not less than a torque threshold value, the second controller 53 decreases the supply amount of the material by decreasing the frequency converted by the inverter 1. For example, when the specific gravity of the material to be pneumatically converted is heavy or when the conveyance amount of the material to be pneumatically conveyed is too much, the pipe resistance is high, so that the torque of the motor 12 is increased to be not less than the torque threshold value. Therefore, in order to decrease the pipe resistance, the supply amount of the material is decreased by decreasing the frequency converted by the inverter 1. By doing this, while the air volume or the air speed is maintained, the mixing ratio μ is decreased to prevent the material density from being too high, so that the material can be pneumatically conveyed under a condition where the pipe resistance is decreased. In addition, stagnation of the material in the pipe can be prevented.

Moreover, since control can be performed so that the torque does not become not less than the threshold value by decreasing the supply amount of the material even when the torque is not less than the torque threshold value, a conventionally required protective device of the suction air source such as a thermal relay that interrupts current or a safety valve for decreasing pressure can be kept from operating. In addition, since control can be performed so that the torque does not become not less than the threshold value, the output of the electric motor of the suction air source can be used at the maximum, so that it is unnecessary to provide a conventionally provided electric motor or suction air source of an excessive rated capacity allowing leeway and this enables power saving.

The display portion 62 has a sound output function such as a buzzer or a speaker, and functions as the notifier. When the physical quantity is not less than the predetermined threshold value at the determiner 57, the display portion 62 provides an indication by characters or the like, or a sound output to that effect. Consequently, even if the torque of the motor 12 becomes not less than the torque threshold value, that condition can be detected quickly. When the torque of the motor 12 exceeds a permissible value, the operation of the material conveyance device may be stopped.

The consumption amount calculator 58 calculates the consumption amount of the material. The consumption amount of the material is, for example, the processing capacity of the molding machine 9 or the like, and indicates how much material is consumed per unit time.

The second controller 53 controls the supply amount of the material by controlling the frequency converted by the inverter 1, according to the consumption amount calculated by the consumption amount calculator 58. Consequently, even when there is a change of a material request at a downstream process such as the molding machine 9, the material responsive to the request change can be pneumatically conveyed. Consequently, the material can be supplied according to the capacity of the molding machine.

The consumption amount of the material can be calculated as follows: In a case where the material is used at the molding machine 9 connected to the collector 6, when the material level in the collector 6 is decreased and the level of the material reaches the detection position of the lower level meter 8 (first detector), a material supply start request signal is output. When the material is pneumatically conveyed and the level of the material reaches the detection position of the upper level meter 7 (second detector) situated above, a material supply stop request signal is output. When the time difference between the supply start time point t1 and the supply end time point t2 is Δt and the amount of material accommodated between the level meters 7 and 8 of the collector 6 is Y, the consumption amount of the material can be calculated by Y/Δt. Consequently, the material processing capacity, that is, the consumption amount at the downstream process can be calculated with a simple structure.

In the above-described embodiment, since the air speed or the air volume in the pipe can be automatically made within a required range, irrespective of the kind of the material, stagnation of the material in the pipe can be prevented and quality degradation of the material can be prevented by preventing snaking or whiskers caused by rubbing of the material in the pipe. Moreover, when the supply amount of the material is changed according to the consumption amount of the material, the mixing ratio can be maintained within a required range and the air speed or the pressure in the pipe can be made within a required range, so that pneumatic conveyance can be performed with stability. Moreover, an operation is unnecessary such as bringing about a required pneumatic conveyance condition by manually adjusting the output of the suction air source (for example, a pump, a blower or the like) and measuring the air volume (or the air speed), the pressure or the like in the pipe every time the material to be pneumatically conveyed is changed or every time the consumption amount of the material is changed. Moreover, the material can be supplied according to the capacity of the molding machine.

While a rotary valve is provided as the material supply portion in the present embodiment, the present invention is not limited thereto, but any appropriate device may be used that is capable of controlling the supply amount of the material (the weight of the material per time).

As this invention may be embodied in several forms without departing from the spirit of essential characteristics thereof, the present embodiments are therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1-14. (canceled)

15. A material conveyance device that has an inverter converting a frequency of an alternating-current source and a suction air source having an electric motor driven by the inverter and pneumatically conveys a material by the suction air source through a pipe for conveying the material, the material conveyance device comprising:
a physical quantity detector that detects a physical quantity related to an output of the inverter; and
a controller that controls an air volume or an air speed by the suction air source based on the physical quantity detected by the physical quantity detector.

16. The material conveyance device according to claim 15,
wherein the physical quantity detector detects at least one of torque, current and power of the electric motor.

17. The material conveyance device according to claim 15,
wherein the controller controls the air volume or the air speed by the suction air source by controlling the frequency converted by the inverter.

18. The material conveyance device according to claim 15, further comprising:
a pressure calculator that calculates a pressure by the suction air source based on the physical quantity detected by the physical quantity detector; and
an air volume calculator that calculates the air volume or the air speed by the suction air source based on the pressure calculated by the pressure calculator and a pressure/air volume characteristic representative of a relationship between the pressure and the air volume of the suction air source,
wherein the controller controls the frequency converted by the inverter so that the air volume or the air speed calculated by the air volume calculator is within a required range.

19. The material conveyance device according to claim 18, further comprising:
an air volume display portion that displays the air volume or the air speed calculated by the air volume calculator.

20. The material conveyance device according to claim 18, further comprising:
a pressure display portion that displays the pressure calculated by the pressure calculator.

21. The material conveyance device according to claim 15, further comprising:
a material supply portion that supplies the material by rotating a material container;
a material supply inverter that converts the frequency of the alternating-current source and adjusts a number of rotations of the material container according to the converted frequency; and
a supply amount controller that controls, in order that a mixing ratio of the material is within a required range, a supply amount of the material by controlling the frequency converted by the material supply inverter, according to the air volume or the air speed by the suction air source.

22. The material conveyance device according to claim 21, further comprising:
a determiner that determines whether the physical quantity detected by the physical quantity detector is not less than a predetermined threshold value or not,
wherein when the physical quantity is not less than the predetermined threshold value at the determiner, the supply amount controller decreases the supply amount of the material by decreasing the frequency converted by the material supply inverter.

23. The material conveyance device according to claim 22, further comprising:
a notifier that, when the physical quantity is not less than the predetermined threshold value at the determiner, provides a notification to that effect.

24. The material conveyance device according to claim 21, further comprising:
a consumption amount calculator that calculates a consumption amount of the material,
wherein the supply amount controller controls the supply amount of the material by controlling the frequency converted by the material supply inverter, according to the consumption amount calculated by the consumption amount calculator.

25. The material conveyance device according to claim 15, wherein the controller controls, in order that the mixing ratio of the material is within the required range, the air volume or the air speed by the suction air source by controlling the frequency converted by the inverter, according to the supply amount of the material.

26. The material conveyance device according to claim 15, wherein the controller controls, in order that the air volume or the air speed by the suction air source is within the required range, the frequency converted by the inverter, according to the supply amount of the material.

27. The material conveyance device according to claim 24, further comprising:
an accommodation portion that captures and accommodates the material conveyed through the pipe; and
a first detector for detecting a material supply start time point and a second detector for detecting a material supply stop time point which the first and the second detectors are provided at different positions of the accommodation portion,
wherein the consumption amount calculator calculates the consumption amount of the material based on a time difference between the supply start time point and the supply stop time point and an amount of material accommodated between the first detector and the second detector of the accommodation portion.

28. A material conveyance method by a material conveyance device that has an inverter converting a frequency of an alternating-current source and a suction air source having an electric motor driven by the inverter and pneumatically conveys a material by the suction air source through a pipe for conveying the material, the material conveying method comprising:
a step of detecting a physical quantity related to an output of the inverter; and
a step of controlling an air volume or an air speed by the suction air source based on the detected physical quantity.
